(19) United States
(12) Patent Application Publication
(10) Pub. No.: US 2006/0037831 A1
(43) Pub. Date: Feb. 23, 2006

(54) Clutch release assembly with counterbalanced release fork

(76) Inventors: John Grillo, Southern Pines, NC (US); Kenneth Picone, Pinehurst, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/919,799

(22) Filed: Aug. 17, 2004

(51) Int. Cl. F16D 23/00

(52) U.S. Cl. 192/99 S

(57) ABSTRACT

A clutch release assembly includes a release fork with a counterbalance portion that causes the release fork to pivot into an assembly position. During assembly, the release fork is pivoted from the assembly position into an operating position. The release fork is mounted on a shaft, which is supported on a clutch housing. The release fork includes a center boss portion with an opening that receives the shaft. The release fork includes tines that extend outwardly from the center boss portion. The tines are positioned to engage a pair of release bearing pads when the release fork is in the operating position. The counterbalance portion holds the release fork in the assembly position. During the assembly, the tines are slid underneath the release bearing pads and then are pivoted into the operating position.

### TECHNICAL FIELD

The subject invention relates to a release fork in a clutch release assembly that is counterbalanced to hold the release fork in an assembly position, allowing the release fork to be installed onto a flywheel housing without interference from a release bearing assembly.

### BACKGROUND OF THE INVENTION

A clutch provides a coupling between an output from an engine and an input to a transmission. The clutch is typically located between a flywheel, which is mounted to the engine, and the transmission. The clutch selectively couples and uncouples a driving output from the flywheel to a driving input to the transmission to allow gear shifting. The clutch includes a clutch release system with a release fork and a release bearing that cooperate to engage and disengage the clutch.

The release fork is mounted to a clutch housing and includes an arm portion and a pair of tines. The release bearing includes a release bearing housing with a pair of release bearing pads. The release bearing is supported on a clutch structure that is mounted to the flywheel. When the clutch housing is assembled onto the flywheel, the tines are positioned to engage the release bearing pads.

Traditionally, the clutch housing is assembled to a flywheel housing and then the release fork is subsequently bolted to the clutch housing. The release fork must be installed after the clutch housing is attached to the flywheel so that the tines can be engaged behind the release bearing pads. This assembly process is time consuming and difficult due to tight space constraints.

The release fork may be installed into the clutch housing prior to attaching the clutch housing to the flywheel but the tines must be manually moved and held out of the way during assembly so that the tines can clear the release bearing. Again, this assembly process is time consuming and difficult due to the tight space constraints.

Thus, there is a need for a release fork that can be pre-assembled onto a clutch housing, prior to attachment of the clutch housing to a flywheel, and which can be moved into a desired operating position without requiring additional assembly steps.

### SUMMARY OF THE INVENTION

A clutch release assembly includes a release fork that is supported on a shaft defining a pivot axis. The shaft is mounted to a clutch housing. The release fork pivots about the pivot axis from an assembly position to an operating position. The release fork includes a counterbalance portion that pivots and holds the release fork in the assembly position. This allows the release fork to be pre-assembled onto the clutch housing, which is then mounted to a flywheel housing. As the clutch housing is assembled onto the flywheel housing, a clutch component engages the release fork to pivot the release fork from the assembly position into the operating position.

In one disclosed embodiment, the release fork includes a center boss with an opening for receiving the shaft. An arm portion extends outwardly from the center boss in a first direction and tines extend outwardly from the center boss in a second direction. The clutch release assembly includes a release bearing housing having release bearing pads. The release bearing housing is part of a clutch assembly that is assembled onto a flywheel. As discussed above, the release fork is pre-assembled onto the clutch housing with the counterbalance portion holding the release fork in the assembly position. In this assembly position, the tines are positioned to clear the release bearing pads as the clutch housing is slid into place. As the clutch housing and flywheel housing are moved closer together during assembly, the clutch component abuts against the tines causing the release fork to pivot into the operating position, at which the tines are positioned to engage the release bearing pads.

The arm portion of the release fork is preferably a curved arm that includes a curved profile. The counterbalance portion is preferably formed as a weighted lug portion positioned near the center boss of the release fork. The curved arm and the weighted lug portion cooperate to pivot the release fork to the assembly position. The arm portion engages a stop to hold the release fork in the assembly position. The stop is preferably formed as part of the clutch housing.

The subject invention provides a release fork that can be pre-assembled onto a clutch housing, and which is moved into an operating position as the clutch housing is assembled onto a flywheel housing without requiring additional assembly steps. These and other features of the present invention can be best understood from the following specification and drawings, the following of which is a brief description.

### BRIEF DESCRIPTION OF THE DRAWINGS

FIG. 1 is a schematic view of a vehicle powertrain with a clutch including a clutch release assembly incorporating the subject invention.

FIG. 2 is a side view of the clutch release assembly, showing a release fork in an assembly position.

FIG. 3 is view similar to that of FIG. 2 but showing the release fork in an operational position.

FIG. 4 is a perspective view of the release fork of FIGS. 2 and 3.

### DETAILED DESCRIPTION OF THE PREFERRED EMBODIMENT

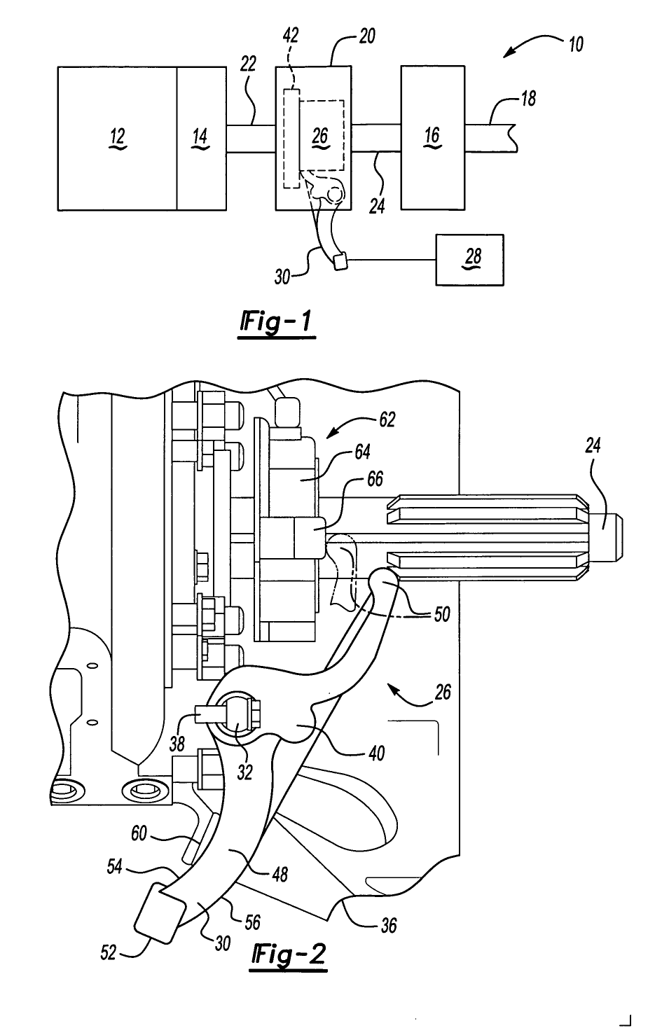

A vehicle powertrain is shown generally at 10 in FIG. 1. The powertrain 10 includes an engine 12, an engine flywheel including a flywheel housing 14 attached to the engine 12, and a transmission 16 having a driving output 18 for driving vehicle wheels (not shown). A clutch 20 is positioned between the transmission 16 and the flywheel housing 14. The clutch 20 selectively couples and uncouples an output 22 from the engine 12 to a driving input shaft 24 and to the transmission 16.

The clutch 20 includes a release assembly, shown generally at 26, that couples and uncouples the output 22 and driving input shaft 24. The release assembly 26 is connected to an actuator 28 that moves the release assembly 26 between coupled and uncoupled positions. Any type of actuator 28 known in the art can be used to control movement of the release assembly 26.

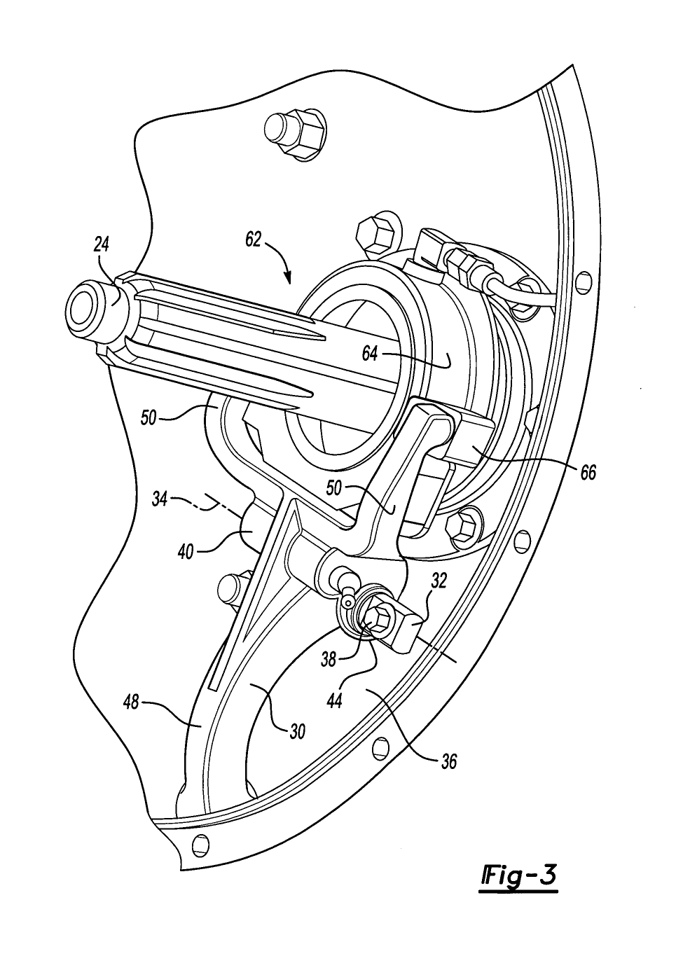

The release assembly 26 is shown in greater detail in FIGS. 2 and 3. The release assembly 26 includes a release fork 30 that is supported on a shaft 32 defining a pivot axis 34. The shaft 32 is mounted to a clutch housing 36 with fasteners 38 at each end (only one end is shown). The release fork 30 pivots about the pivot axis 34 from an assembly (FIG. 2) position to an operating position (FIG. 3). The release fork 30 includes a counterbalance portion 40 that pivots and holds the release fork 30 in the assembly position.

The counterbalance portion 40 allows the release fork 30 to be pre-assembled onto the clutch housing 36, which can then be subsequently mounted to the flywheel housing 14. The clutch housing 36 also supports the driving input shaft 24. The driving input shaft 24 is spaced apart from and transverse to the pivot axis 34. The clutch housing 36 is assembled onto the flywheel housing 14 by sliding the driving input shaft 24 into the flywheel housing 14. During this assembly step, a clutch component, schematically shown at 42 in FIG. 1, abuts, engages, or pushes against the release fork 30 causing the release fork 30 to pivot from the assembly position into the operating position. Any type of clutch component 42 can move the release fork 30 to the operating position depending upon the specific clutch configuration. For example, a clutch disc, clutch cover, a clutch housing portion, or the actuator 28, could be used to move the release fork 30.

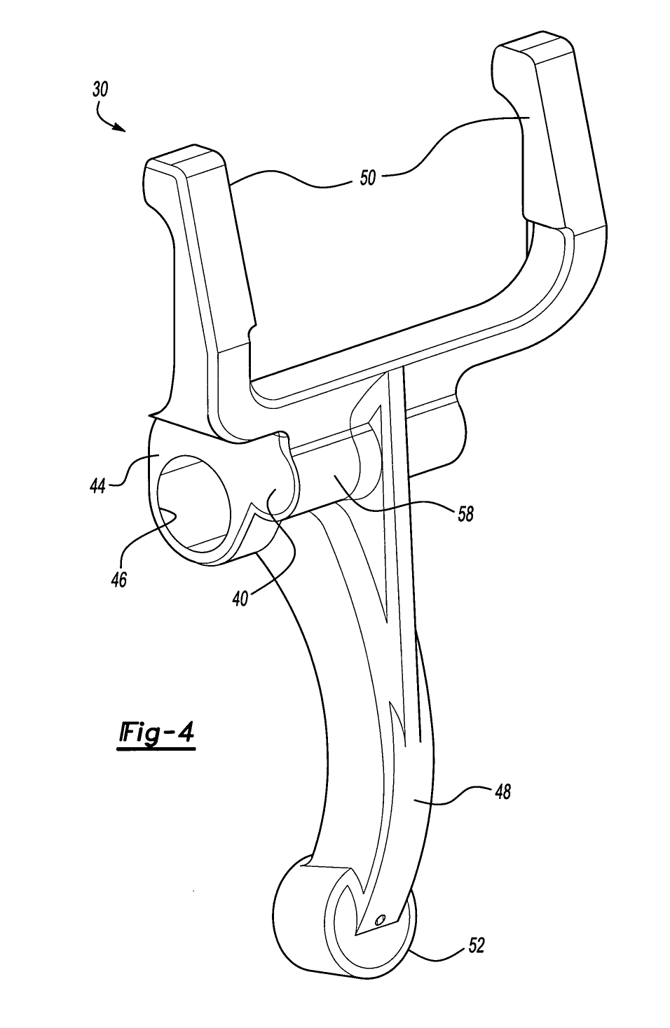

As shown in FIG. 4, the release fork 30 includes a center boss 44 with an opening 46 for receiving the shaft 32. An arm portion 48 extends outwardly from the center boss 44 in a first direction and tines 50 extend outwardly from the center boss 44 in a second direction. The arm portion 48 includes a curved profile that extends from the center boss 44 to a distal arm end 52. The distal arm end 52 is connectable to the actuator 28 (FIG. 1). The curved profile provides a concave surface 54 that faces the clutch housing 36 and a convex surface 56 that faces the clutch component 42.

One part of the counterbalance portion 40 is formed as a weighted lug portion 58 that extends outwardly from the center boss 44. The weighted lug portion 58 cooperates with the arm portion 48 having the curved profile, to pivot the release fork 30 to the assembly position. The weighted lug portion 58 cooperates with the arm portion 48 to offset the center of gravity of the release fork 30 relative to the shaft 32, which automatically causes the release fork 30 to pivot in a clockwise direction as shown in FIG. 2.

The release fork 30 pivots until the arm portion 48 hits a stop 60. The stop 60 is preferably formed as part of the clutch housing 36, as shown in FIG. 2. The stop 60 holds the release fork 30 in the assembly position.

The release assembly 26 includes a release bearing assembly 62 with a release bearing housing 64 that includes release bearing pads 66. Preferably, the release bearing housing 64 includes a pair of release bearing pads 66 (only one is shown) with one tine 50 engaging each release bearing pad 66 in the operating position. The release bearing housing 64 is part of the clutch 20 that is assembled onto the flywheel. As discussed above, the release fork 30 is pre-assembled onto the clutch housing 36 with the counterbalance portion 40 automatically pivoting the release fork 30 to the assembly position.

In this assembly position, the tines 50 are positioned to clear the release bearing pads 66 as the clutch housing 36 is installed onto the flywheel housing 14. During assembly, the driving input shaft 24 is slid in a linear direction towards the flywheel housing 14. The tines 50 are slid underneath the release bearing pads 66, which protrude radially outwardly from the release bearing housing 64. As the clutch housing 36 and flywheel housing 14 are moved closer together during assembly, the clutch component 42 abuts against the tines 50 causing the release fork 30 to automatically pivot into the operating position where the tines 50 are positioned to engage the release bearing pads 66 as shown in FIG. 3. Also, connection of the actuator 28 to the release fork 30 positions and holds the release fork 30 in the operating position.

The subject invention provides a release fork 30 that can be pre-assembled onto a clutch housing 36 and which is moved into an operating position as the clutch housing 36 is assembled onto a flywheel housing 14, eliminating additional assembly steps and reducing assembly cost. Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A clutch release assembly comprising:
a shaft supported by a clutch housing, said shaft defining a pivot axis;
a release fork supported on said shaft and including a counterbalance portion wherein said counterbalance portion pivots said release fork about said pivot axis to an assembly position to establish a clearance between said release fork and a clutch release bearing pad.

2. The clutch release assembly according to claim 1 wherein said release fork is pivoted from said assembly position into an operating position where said release fork is positioned to engage said release clutch bearing pad as said clutch housing is assembled onto a flywheel housing.

3. The clutch release assembly according to claim 2 including a stop that holds said release fork in said assembly position.

4. The clutch release assembly according to claim 3 wherein said stop is formed as part of said clutch housing.

5. The clutch release assembly according to claim 2 wherein said release fork includes a center boss with an opening for receiving said shaft, an arm portion extending outwardly from said center boss in a first direction, and at least one tine extending outwardly from said center boss in a second direction.

6. The clutch release assembly according to claim 5 wherein said arm portion includes a curved profile extending generally from said center boss portion to a distal arm end.

7. The clutch release assembly according to claim 6 wherein said curved profile provides a concave surface facing said clutch housing and a convex surface facing a clutch component.

8. The clutch release assembly according to claim 6 wherein said distal arm end is connectable to an actuator component.

9. The clutch release assembly according to claim 5 wherein said counterbalance portion comprises a weighted lug portion extending outwardly from said center boss that cooperates with said arm portion to pivot said release fork into said assembly position.

10. The clutch release assembly according to claim 2 wherein said clutch release bearing pad is formed on a release bearing housing centrally positioned within a clutch.

11. The clutch release assembly according to claim 10 wherein said release bearing housing includes an opening that receives an input shaft, said input shaft being spaced apart from and transverse to said pivot axis.

12. A method of assembling a clutch release assembly comprising:
(a) mounting a release fork with a counterbalance portion to a clutch housing for pivotal movement about a pivot axis; and
(b) the counterbalance portion pivoting the release fork to an assembly position to establish clearance relative to clutch release bearing pads.

13. The method according to claim 12 including
(c) pivoting the release fork to an operating position as the clutch housing is assembled onto a flywheel housing.

14. The method according to claim 13 wherein step (c) includes abutting a clutch component against the release fork to pivot the release fork into the operating position.

15. The method according to claim 13 wherein the release fork includes a center boss, an arm extending outwardly from the center boss in a first direction, and a pair of tines extending outwardly from the center boss in a second direction, and including sliding the pair of tines underneath the clutch release bearing pads prior to step (c).

16. The method according to claim 13 wherein the clutch release bearing pads are formed on a release bearing housing and wherein step (b) includes sliding the release fork toward the release bearing housing such that release fork tines clear the clutch release bearing pads when the release fork is in the assembly position.

17. The method according to claim 12 wherein the counterbalance portion biases the release fork in the assembly position.

18. The method according to claim 17 including abutting a portion of the release fork against the clutch housing to define a stop that holds the release fork in the assembly position.
